(19) United States
(12) Patent Application Publication
(10) Pub. No.: US 2019/0115597 A1
(43) Pub. Date: Apr. 18, 2019

(54) CONDUCTIVE GRAPHITE FLUORIDE AND A METHOD OF MAKING

(71) Applicant: INDIANA UNIVERSITY RESEARCH AND TECHNOLOGY CORPORATION, Indianapolis, IN (US)

(72) Inventors: Liang-shi LI, Bloomington, IN (US); Yijun LIU, Bloomington, IN (US)

(21) Appl. No.: 16/161,858

(22) Filed: Oct. 16, 2018

Related U.S. Application Data
(60) Provisional application No. 62/573,641, filed on Oct. 17, 2017.

(51) Int. Cl. H01M 4/583; H01M 4/62; H01M 10/052; C08G 73/02; C08K 3/04

(52) U.S. Cl. CPC H01M 4/5835; H01M 4/624; C08K 3/04; H01M 10/052; C08G 73/0266; H01M 4/623

(57) ABSTRACT

The present disclosure relates to materials and more particularly to conductive materials. More particularly, the present disclosure relates to conductive materials comprising graphite fluoride and a polymer.

### CROSS-REFERENCE TO RELATED APPLICATIONS

This application claims the benefit of U.S. Provisional Patent Application No. 62/573,641, filed Oct. 17, 2017, the disclosure of which is hereby incorporated by reference in its entirety.

### BACKGROUND

Graphite fluoride (GF) has been widely used as an electrode material for batteries. However, a major difficulty with this application is that GF is not conductive, therefore requiring strategies to overcome this difficulty.

The poor electrical conductivity of GF has limited its use as an electrode material for batteries. Various strategies have been developed to overcome this difficulty, such as mechanically mixing GF with conductive materials such as carbon nanotubes, metal particles or wires, or conductive polymers. These methods are costly and not scalable.

### SUMMARY

In one aspect, the present disclosure provides a composite comprising graphite fluoride and a polymer mixed with the graphite fluoride. In some embodiments, the polymer comprises aniline, derivatives of aniline, pyrrole, derivatives of pyrrole, thiophene, derivatives of thiophene, or mixtures or combinations thereof. In some embodiments, the polymer comprises polyaniline. In some embodiments, the composite may have a C/F atomic ratio less than about 1/1.1, less than about 1/1, less than about 1/0.9, or less than about 1/0.85.

In another aspect, the present disclosure provides a method for forming a composite comprising contacting graphite fluoride with a monomer to form a composite.

In another aspect, the present disclosure provides a cell for a battery comprising a composite as described herein. In some embodiments, the composite comprises graphite fluoride and a polymer.

Additional features of the present disclosure will become apparent to those skilled in the art upon consideration of illustrative embodiments exemplifying the best mode of carrying out the disclosure as presently perceived.

### BRIEF DESCRIPTIONS OF THE DRAWINGS

The detailed description particularly refers to the accompanying figures in which:

FIGS. 1A-B show defluorination of GF by weak reductants. FIG. 1A shows an F-NMR spectrum of the supernatant from the GF-TMPD reaction mixture. FIG. 1B shows Raman spectra (514.5 nm excitation) of the solid products after GF was exposed to various reductants compared with that of the starting GF.

FIG. 2 shows IR spectra of GF and the prepared GF-polyaniline composite materials, both obtained in KBr pellets. The 3354 cm⁻¹ band is due to N-H stretching, and the 753 and 692 cm⁻¹ bands due to residual aniline. The broad peak at 1200 cm⁻¹ is due to C-F stretching.

FIG. 3A shows a high-frequency region of the impedance spectra of Li/CFx batteries made with GF and the GF-polyaniline composite materials, respectively, in the cathode. Inset: full-range spectra measured between 200 kHz and 0.1 Hz. FIG. 3B shows discharge curves of the Li/CFx batteries made with GF and the GF-polyaniline composite materials, respectively. The discharge rate is C/50. The measurements were stopped when the discharge voltage decreased to 1.5 V from the initial 2.5 V, with a specific capacity of 526 mAh g⁻¹ (based on mass of GF) and 659 mAh g⁻¹ (based on mass of the GF-polyaniline composite used).

FIG. 4A shows shift of C is peak to lower binding energy, due to partial conversion of F-bonded sp³ C (290.3 eV) to sp² C (284.8 eV) and, to a far less extent, presence of polyaniline (4%). FIG. 4B shows the decrease of fluorine content from the original 1.1 F/C (unwashed GF) to 0.8 F/C. FIG. 4C shows the increase of nitrogen content by 0.7% due to presence of aniline oligomers and polymers.

### DETAILED DESCRIPTION

Described herein is a method for making polymer-intercalated graphite fluoride, sometimes called a composite. Illustratively, the polymer may be distributed throughout the graphite fluoride as a result of the reaction between graphite fluoride and a monomer. In some embodiment, and without being bound by theory, graphite fluoride can act as an oxidant and the monomer acts as a reductant, and the monomer can polymerize when oxidized. In some embodiments, methods are described herein that form a composite where a polymer is mixed throughout a graphite fluoride. In some embodiments, the methods described herein may produce a material having improved electrical conductivity. The materials provided by the methods described herein, having improved properties, may lead to improved lithium battery performance. In some embodiments, the material is made with a simple, scalable method as described herein.

In accordance with the present disclosure, a composite may comprise graphite fluoride mixed with a polymer. In some embodiments, the polymer can be distributed throughout the graphite fluoride. Illustratively, the graphite fluoride can be mixed with the polymer on a nanometer scale. Without being bound by theory, the polymer may be bound to the graphite fluoride through Van der Walls forces.

Illustratively, the composite may have a particular carbon/fluorine (C/F) atomic ratio as determined by x-ray photoelectron spectroscopy (XPS). In some embodiments, the composite may have a C/F atomic ratio less than about 1/1.1, less than about 1/1.0, less than about 1/0.9, or less than about 1/0.85. In some embodiments, the C/F atomic ratio is greater than about 1/0.7. In some embodiments, the composite may have a C/F atomic ratio of about 1/0.65, about 1/0.7, about 1/0.75, about 1/0.8, about 1/0.85, about 1/0.9, about 1/0.95, about 1/1, or about 1/1.05. In some embodiments, the C/F ratio is in a range of about 1/0.65 to about 1/1, about 1/0.7 to about 1/1, about 1/0.7 to about 1/0.9, about 1/0.7 to about 1/0.85, or about 1/0.75 to about 1/0.85.

In some embodiments, the polymer comprises aniline, derivatives of aniline, pyrrole, derivatives of pyrrole, thiophene, derivatives of thiophene, or mixtures or combinations thereof. In some embodiments, the polymer is polyaniline. In some embodiments, the aniline is a substituted aniline.

The composite may have a certain percentage by weight of polymer. In some embodiments, the composite has a polymer content less than about 40%, less than about 30%, less than about 20%, less than about 10%, less than about 8%, less than about 6%, or less than about 5% by weight of the composite. In some embodiments, the composite has a polymer content at least about 1%, at least about 2%, at least about 3%, at least 5%, or at least 10% by weight. In some embodiments, the percentage by weight of polymer is about 0.1%, about 0.2%, about 0.3%, about 0.4%, about 0.5%, about 0.6%, about 0.8%, about 1%, about 1.2%, about 1.4%, about 1.6%, about 1.8%, about 2%, about 2.2%, about 2.4%, about 2.6%, about 2.8%, about 3%, about 3.2%, about 3.4%, about 3.6%, about 3.8%, about 4%, about 4.5%, about 5%, about 6%, about 7%, about 8%, about 10%, about 15%, about 20%, about 25%, about 30%, about 35%, or about 40%. In some embodiments, the composite has a percentage by weight of polymer in a range of about 0.1% to about 40%, about 0.1% to about 25%, about 0.1% to about 20%, about 0.1% to about 15%, about 0.1% to about 10%, about 0.1% to about 6%, about 0.5% to about 6%, about 1% to about 6%, about 1% to about 5%, or about 1% to about 4%.

In some embodiments, the composite has an IR spectrum comprising a band at about 1594 cm⁻¹, about 1497 cm⁻¹, about 1310 cm⁻¹, about 1259 cm⁻¹, about 800 cm⁻¹, or a combination thereof, as shown in FIG. 2. In some embodiments, the IR spectrum comprises at least two bands selected from the group consisting of 594 cm⁻¹, 1497 cm⁻¹, 1310 cm⁻¹, 1259 cm⁻¹, or 800 cm⁻¹. Illustratively, some of these bands may be representative of polyaniline. Illustratively, some of these bands may be representative of emeraldine.

In another aspect, the present disclosure provides a method for forming a graphite fluoride composite comprising contacting graphite fluoride in the presence of a monomer to form a composite. In some illustrative embodiments, the method may be used in large-scale operations. In some embodiments the monomer is aniline. In some illustrative embodiments, the step of contacting is performed in the presence of a reductant.

In some embodiments, the reductant has an E° in a range of about 0.1 V to about 0.7 V vs. the Normal Hydrogen Electrode (NHE). In some embodiments, the reductant is decamethylferrocene (FeCp₂*), tetrathiafulvalene (TTF), decamethylosmocene (OsCp₂*), or tributyltin hydride.

In some embodiments, the step of contacting is performed in a solution. In some embodiments, the solution comprises a solvent. In some embodiments, the solvent comprises acetonitrile, water, or a mixture thereof. In some embodiments, the solution has a pH less than about 12, less than about 10, or less than about 7. In some embodiments, the pH of the solution is about 1, about 2, about 3, about 4, about 5, about 6, about 7, about 8, about 9, about 10, about 11, or about 12. In some embodiments, the pH is selected from a range of about 1 to about 12.

In some embodiments, the solution comprises an acid. The acid may be an organic acid or a mineral acid. The acid may be hydrochloric acid, formic acid, sulfuric acid, nitric acid, phosphoric acid, or acetic acid. In some embodiments, the acid comprises acetic acid.

In some embodiments, the method uses a ratio of aniline molecules to unpaired electrons. Illustratively, any amount of excess aniline per unpaired electron may be used. In some embodiments, the ratio is at least 1 aniline per unpaired electron, at least 2 anilines per unpaired electron, at least 20 anilines per unpaired electron, or at least 50 anilines per unpaired electron. In some embodiments, the ratio is about 700 aniline molecules to about 1 unpaired electron in the graphite fluoride. In some embodiments, the aniline is recovered and reused.

In some embodiments, the step of contacting is performed for a particular duration of time. In some embodiments, the duration of time is up to about 15 days or up to about 30 days. In some embodiments, the duration of time is about 1 day, about 3 days about 5 days, 7 days, about 10 days, about 15 days, about 20 days about 25 days, or about 30 days. In some embodiments, the duration of time is selected from a range of about 1 day to about 30 days, about 1 day to about 20 days, about 3 days to about 20 days, about 3 days to about 15 days, or about 3 days to about 10 days.

In some embodiments, the solution comprises a mixture of a solvent and an acid at a particular ratio. In some embodiments, the acid:solvent ratio is about 10⁻⁷:1, about 0.01:1, about 0.1:1, 1:1, about 2:1, about 3:1, about 5:1, about 7:1, or about 10:1. In some embodiments, the acid:solvent ratio is selected from a range about 1:1 to about 10:1 or about 1:1 to about 10⁵:1.

In some embodiments, the method comprises the step of mixing. Illustratively, the mixing can include mechanical mixing. In some embodiments, the step of mixing is done in the absence of mechanical mixing. When the step of mixing does not include mechanical mixing, the monomers may diffuse into the pores of the graphite.

Graphite fluoride with various fluorine content may be used as cathode materials for primary batteries. Illustratively, a primary battery employs lithium as the anode. Because of the light mass and small radii of lithium and fluoride ions, these types of batteries may have one of the highest theoretical specific energy (e.g., 2180 Wh/kg for x=1.0) among solid cathode systems.

In accordance with another aspect of the present invention, the composite may be used in a material for a cell in a battery. In some embodiments, the material is used as a cathode in a cell for a battery. Illustratively the material may comprise the composite and a binder. In some embodiments, the binder is polyvinylidene fluoride (PVdF). In some embodiments, the material comprises carbon black.

In some embodiments, the material comprises a certain percentage by weight of the composite. In some embodiments, the material comprises at least 40%, at least 50%, about 60%, at least 65%, at least 70%, at least 75%, at least 80%, at least 85%, or at least 90% composite.

In some embodiments, the cell has an internal resistance. In some embodiments, the internal resistance of the cell is less than about 150 ohms, less than about 125 ohms, less than about 100 ohms, less than about 75 ohms, less than about 50 ohms, less than about 25 ohms, less than about 15 ohms, less than about 12 ohms, less than about 10 ohms, or less than about 8 ohms. In some embodiments, the internal resistance of the cell is about 5 ohms, about 6 ohms, about 7 ohms, about 8 ohms, about 9 ohms, about 10 ohms, about 11 ohms, about 12 ohms, about 13 ohms, about 14 ohms, about 15 ohms. about 25 ohms, about 30 ohms, about 35 ohms, about 40 ohms, about 50 ohms, about 60 ohms, about 70 ohms, about 80 ohms, about 90 ohms, about 100 ohms, about 110 ohms, about 120 ohms, about 130 ohms, about 140 ohms, or about 150 ohms. In some embodiments, the internal resistance of the cell is about 5 ohms to about 150 ohms, about 5 ohms to about 100 ohms, about 5 ohms to about 70 ohms, about 5 ohms to about 50 ohms, about 5 ohms to about 40 ohms, about 5 ohms to about 30 ohms, about 5 ohms to about 25 ohms, about 5 ohms to about 15 ohms, about 5 ohms to about 12 ohms, or about 5 ohms to about 10 ohms.

In some embodiments, the cell has a specific capacity of at least 550 mAhg⁻¹, at least 600 mAhg⁻¹, or at least 650 mAhg⁻¹ at discharge rate of C/50. In some embodiments, the cell has a specific capacity of about 550 mAhg⁻¹, about 575 mAhg⁻¹, about 600 mAhg⁻¹, about 625 mAhg⁻¹, about 650 mAhg⁻¹, about 675 mAhg⁻¹, about 700 mAhg⁻¹, about 725 mAhg⁻¹, about 750 mAhg⁻¹, about 775 mAhg⁻¹, about 800 mAhg⁻¹, about 825 mAhg⁻¹, or about 850 mAhg⁻¹. In some embodiments, the specific capacity is about 660 mAhg⁻¹.

### EXAMPLES

### Example 1

General Experimental Methods

Graphite fluoride (>61 wt. % F) was purchased from Sigma-Aldrich. It was washed with deionized water at room temperature and dried at 150° C. under vacuum for at least 24 hours before use. X-ray photoelectron spectroscopy (XPS) shows that it has a stoichiometry of CF_{1.0}. Solvents such as acetonitrile (MeCN), dichloromethane (DCM), toluene, and cyclohexane were pre-dried and bubbled with N₂ for 30 min to remove oxygen before use. Unless otherwise noted, reagents were purchased from Aldrich or Alfa and were used as received.

The XPS spectra were recorded using a PHI Versa Probe II Scanning X-ray Microprobe instrument with a monochromatic Al Kα X-ray source under ultrahigh vacuum (UHV) conditions. The powder samples were pelletized for XPS measurements. Scotch Double Sided Tape (6137H-2PC-MP) was used for the sample mounting. The C is peak of C-F at 290.4 eV was used as an internal standard for binding energy scale calibration.¹ Survey scans were recorded using PHI software SmartSoft-XPS v2.0 at the 187.75 eV pass energy with the step of 0.4 eV. High resolution F is and C is XPS spectra with the 0.1 eV energy step were recorded at 2.95 eV and 11.75 eV pass energies correspondingly. The PHI MultyPack v9.0 software was used for data processing. Shirley background was used for quantification. In general multiple spectra were recorded on different sample areas, to quantitatively evaluate reproducibility and avoid artifacts or detect radiation damage.

For a typical reaction of GF with reductants, a mixture of typically 0.2 g GF, 0.05 g reductant and 2 mL MeCN, held in a polypropylene tube, was stirred for various periods of time (ranging from hours to as long as 7 days) at room temperature. The solids were isolated by centrifugation or filtering and then were repetitively washed with MeCN, DCM, toluene, and hexane until the supernatant was colorless. Reactions of GF with vapors of reductants were also conducted, by putting typically 0.1 g GF and 0.05 g reductant in separate arms of an H-shaped reactor connected to a vacuum line. The reductants were cooled with liquid nitrogen. The reactor was evacuated and then sealed by means of a stopcock so that GF was exposed to only the reductant vapor for up to 48 hour. In all cases XPS showed some incorporation of heteroatoms from the reductants to the solid products, i.e., 0.6 atom % Fe(III) (E_{b} 710.2 eV and 723.3 eV) in the case of FeCp₂*, 1.0 atom % N (E_{b} 400.8 eV) in the case of TMPD, 1.2 atom % S (E_{b} 164.2 eV and 165.3 eV) in the case of TTF, and 0.1 atom % Os(III) (E_{b} 55.7 eV and 53.3 eV) in the case of OsCp₂*.

### Example 2

GF Reduction

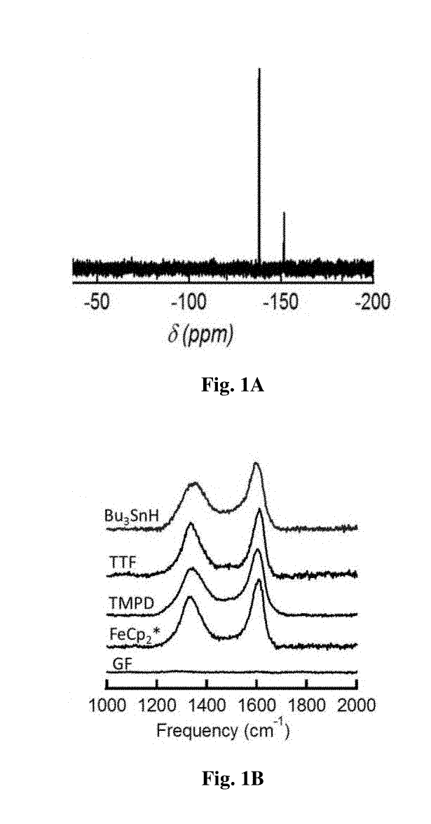

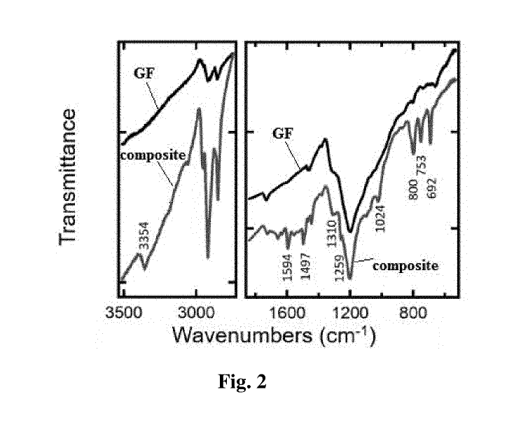

FIG. 1A is the fluorine-NMR spectrum of the supernatant of the reaction mixtures with TMPD, showing appearance of soluble fluorine-containing species after the reaction. The chemical shift of the peaks (−130 and −152 ppm, relative to CFCl₃) correspond to SiF₆²⁻ and BF₄⁻, respectively, due to corrosion of the borosilicate glass NMR tube by F⁻. The same results were also observed in reaction mixtures with FeCp₂* or TTF.

The solids from the reaction mixture showed decreased fluorine content and formation of sp²-hybridized carbon. X-ray photoelectron spectroscopy (XPS) measurements of the solid product obtained with TMPD showed F/C=0.71 after a week, significantly lower than the starting F/C atomic ratio of 1.0 (Table 1). The Raman spectrum of this material (514.5 nm excitation, FIG. 1B, showed new peaks at 1330 (FWHM 50) and 1600 (FWHM 30) cm⁻¹ (intensity ratio ˜1.1:1). This can be interpreted as either graphene with extremely high defect density or a continuous network of C═C bonds, indicating conversion of sp³-carbon in GF to sp²-carbon. This is consistent with the color change of the solids from the original pale gray to black, as can be visualized. However, X-ray diffraction measurements didn't reveal any long-range structural order or graphite formation.

TABLE 1
Fluorine content of GF, GF-TTF and GF-TMPD

| Sample | GF | GF-TTF | GF-TMPD |
|---|---|---|---|
| F/C Ratio | 1.00 | 0.927 | 0.710 |

### Example 3

GF Reduction with OsCp₂*

0.15 g GF and 0.07 g OsCp₂* were mixed in 1.5 ml MeCN, contained in a polypropylene tube, stirred at room temperature for 6 days after which the reaction mixture was filtered. The solids were washed with 5 mL MeCN, four 5 mL portions of warm (50° C.) toluene and 5 mL hexane. XPS analysis demonstrated that the product contained 0.1 atom % Os with E_{b} Os(4f_{5/2}) 55.7 eV and Os(4f_{7/2}) 53.3 eV. The Os binding energies are in agreement with literature data for [OsCp₂*][BF₄].

### Example 4

Aniline Polymerization

About 10 g of GF was added to 50 mL of acetonitrile, 40 mL of acetic acid, and 10 mL of water. This was stirred for 30 days at room temperature. The solids in the reaction mixtures were subsequently washed repetitively with acetonitrile, water, ethanol and their mixtures to remove unreacted aniline and soluble reaction products until the supernatant appeared colorless. The resulting graphite fluoride composite comprised about 4% aniline.

### Example 5

Composite Characterization

IR spectra confirmed the presence of polyaniline in the solid products of the GF-aniline reaction. Shown in FIG. 2, the IR bands at 1594, 1497, 1310, 1259, and 800 cm⁻¹ (red curve) are consistent with emeraldine, i.e., the conductive form of polyaniline. Among these the 1595 and 1497 cm⁻¹ bands are assigned to quinonoid and benzenoid ring-stretching vibrations, respectively. The 1310 and 1259 cm⁻¹ bands are due to C—N stretching, and the 800 cm⁻¹ band due to out-of-plane C—H bending mode of the p-disubstituted phenyl rings. XPS was employed to measure the fluorine content in the solid products, which showed that the C/F atomic ratio changed from the original 1/1.1 to 1/0.80. From N content the weight percentage of polyaniline in the solids is estimated to be less than 4%. Therefore, mixing aniline with GF produces sp²-carbon from partial reduction of the GF and at the same time conjugated polyaniline due to the oxidative polymerization of aniline, both of which could contribute to electrical conductivity of the composite material. Because electron transfer occurs over a short distance, the polymerization may occur only at the solid/liquid interface, leading to intimate mixing of polyaniline with partially reduced GF.

### Example 6

Composite Characterization

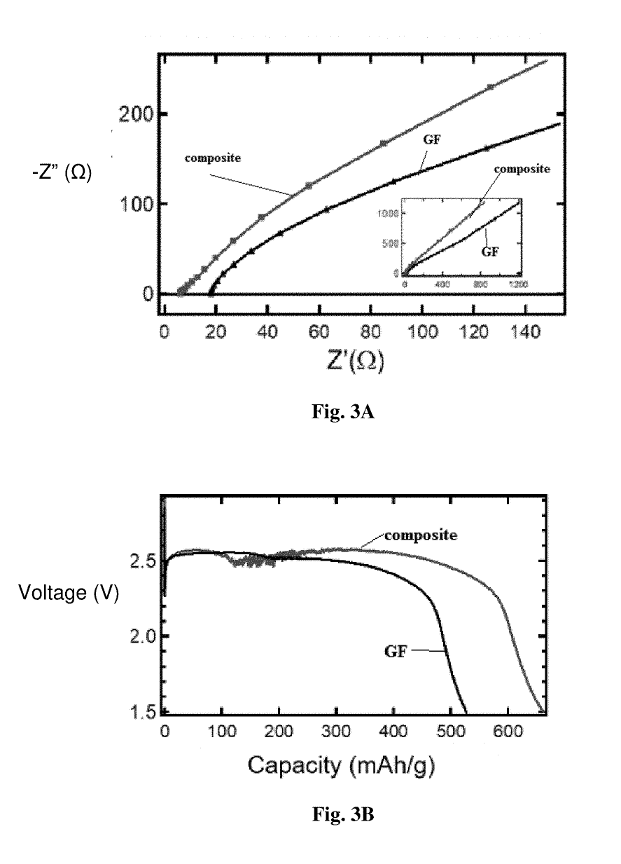

Li/CFx coin cells were made with either GF or the GF-polyaniline composite as the cathode materials, and tested their discharge characteristics. For the cathode, either of the two materials were mixed with carbon black, polyvinylidene fluoride (PVDF) binder at the weight ratio of 85:10:5. Lithium metal sheet was used as the anode, and coin cells were assembled under identical conditions. Shown in FIG. 3A are the Nyquist plots of the impedance of the cells measured between 200 kHz to 0.1 Hz (black for GF and grey for GF-polyaniline composite). As indicated by the intercepts on the x-axis (i.e., real part of the impedance, Z′), the cells made with the GF-polyaniline composite have internal resistance only a third of that of cells made with GF (6.2Ω vs. 17.9Ω). This may be attributed to contributions from both the sp²-carbon formed in reduced GF and the polyaniline in the composite, having intimate electrical contact. This leads to superior discharge capacity, as shown in FIG. 3B. At the discharge rate of C/50, cells made with GF-polyaniline yielded a specific capacity of 659 mAh g⁻¹ (for voltage drop from the initial 2.5 V to 1.5 V). This is significantly higher than 526 mAh g⁻¹ for cells made with GF, despite the lower fluorine content in the GF-polyaniline composite.

### Example 7

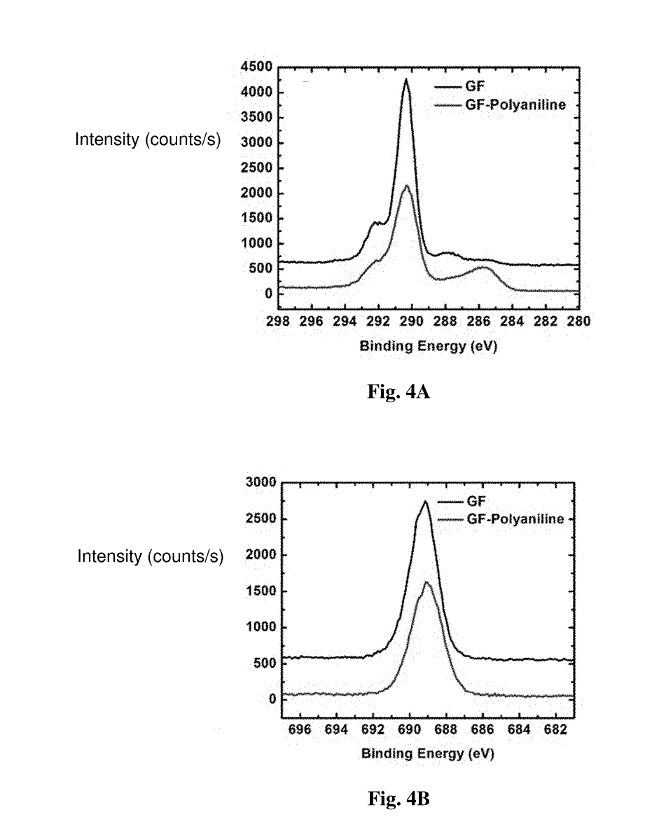

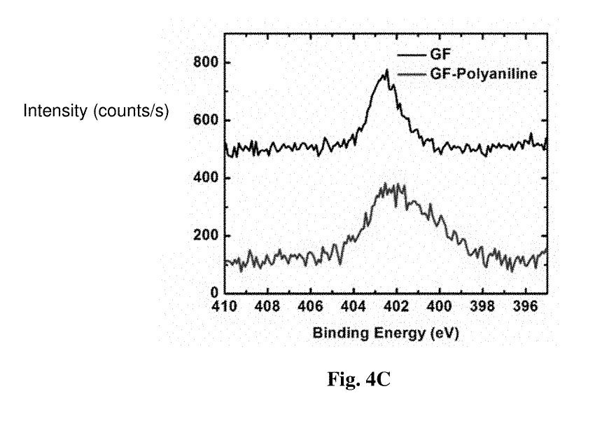

For GF-aniline reactions, the high-resolution XPS spectra are normalized according to the C is peak (294-284 eV). FIG. 4A shows shift of C is peak to lower binding energy, due to partial conversion of F-bonded sp³ C (290.3 eV) to sp² C (284.8 eV) and, to a far less extent, presence of polyaniline (4%). FIG. 4B shows the decrease of fluorine content from the original 1.1 F/C (unwashed GF) to 0.8 F/C. FIG. 4C shows the increase of nitrogen content by 0.7%, due to presence of aniline oligomers and polymers.

### Example 8

For the aniline polymerization and the battery work, the graphite fluoride was used as received. XPS shows it has a C/F atomic ratio of 1.0/1.1 and thus the material is denote CF_{1.1}. CF_{1.1} electrodes were prepared by mixing the graphite fluoride powder and Super P carbon in a mortar for fully milling. Then the polyvinylidene difluoride (PVdF) binder solution in N-methylpyrrolidone (NMP) was added into the mortar. The ratios of CF_{1.1}:Super P:PVdF were 85:5:10 wt. %. The mixture was grinded and dispersed for more than 1 hour to prepare a slurry. Before making the electrode, an aluminum foil was cleaned by 0.02 M sodium hydroxide (NaOH) solution in isopropanol (IPL), then cleaned with de-ionized water and acetone, and then dried. The slurry was then coated onto the aluminum foil with a casting knife, followed by evaporating the NMP solvent at 60° C. under vacuum for 12 hrs. The electrodes were then cut into circular disks with 1.1 cm diameter (0.97 cm² in area). The electrodes were rolled by a rolling machine before using. The GF-polyaniline electrodes were made using the graphite fluoride composite of Example 4 following the same procedures with the same weight ratios. Both electrodes have similar thickness and mass loading.

Electrochemical performances of the cells were evaluated within standard CR2032 coin cell casings (D20.0×H3.2 mm). The coin cells were assembled in the glove box. First, 1.0 M LiPF₆ in ethylene carbonate (EC)/diethyl carbonate (DEC) electrolyte (15 μL) was added into the electrode. Then a Celgard 2400 polypropylene separator was placed on the top of the electrode followed by adding 15 μL electrolyte on the top of the separator. Finally, lithium metal anode with a nickel foam spacer was placed on the separator. The cell was crimped and taken out of the glove box. The cell was kept rest for 15 hours before test.

The cells were galvanostatically discharged to 1.5 V on an Arbin battery cycler at a fixed C-rate of C/50, with 1C=896 mA g⁻¹ for GF, and 1C=788 mA g⁻¹ for GF-polyaniline. The theoretical specific capacities were calculated based on the contents of fluorine in GF and GF-polyaniline. The specific capacity values shown in this work are calculated by dividing the capacities obtained by the mass of active materials. Electrochemical impedance spectroscopy (EIS) data were collected with a Bio-Logic VSP impedance analyzer in the frequency range of 200 kHz-0.1 Hz on cells.

1. A composite comprising,
graphite fluoride, and
a polymer distributed throughout the graphite fluoride.

2. The composite of claim 1, wherein the polymer comprises aniline, derivatives of aniline, pyrrole, derivatives of pyrrole, thiophene, derivatives of thiophene, or mixtures or combinations thereof polyaniline.

3. The composite of claim 2, wherein the polymer is polyaniline.

4. The composite of claim 1, wherein the composite has an IR spectra comprising a band at about 1594 cm⁻¹, about 1497 cm⁻¹, about 1310 cm⁻¹, about 1259 cm⁻¹, or about 800 cm⁻¹.

5. The composite of claim 4, wherein the IR spectra comprises at least two bands selected from the group consisting of about 594 cm⁻¹, about 1497 cm⁻¹, about 1310 cm⁻¹, about 1259 cm⁻¹, or about 800 cm⁻¹.

6. The composite of claim 1, wherein the composite has a C/F atomic ratio less than about 1/1.1, less than about 1/1, less than about 1/0.9, or less than about 1/0.85.

7. The composite of claim 6, wherein the C/F atomic ratio is greater than about 1/0.7.

8. The composite of claim 1, wherein the composite has a polymer content less than about 10%, less than about 8%, less than about 6%, or less than about 5% by weight of the composite.

9. A method for forming a graphite fluoride composite, the method comprising
contacting graphite fluoride with a monomer to form a composite,
wherein the monomer is aniline, a derivative of aniline, pyrrole, a derivative of pyrrole, thiophene, a derivative of thiophene, or a mixture or a combination thereof.

10. The method of claim 9, wherein the composite has an IR spectra comprising a band at about 1594 cm⁻¹, about 1497 cm⁻¹, about 1310 cm⁻¹, about 1259 cm⁻¹, or about 800 cm⁻¹.

11. The method of claim 10, wherein the composite has a C/F atomic ratio less than about 1/1.1, less than about 1/1.0, less than about 1/0.9, or less than about 1/0.085.

12. The method of claim 11, wherein the C/F atomic ratio changed from about 1/1.1 to about 1/0.80.

13. The method of claim 9, wherein the step of contacting is performed in a solution comprising a solvent and an acid.

14. The method of claim 13, wherein the solvent is acetonitrile, water, or a mixture thereof.

15. The method of claim 13, wherein the acid is hydrochloric acid, formic acid, sulfuric acid, nitric acid, phosphoric acid, or acetic acid.

16. The method of claim 15, wherein the solution has a pH less than about 12, less than about 10, or less than about 7.

17. A cell for a battery comprising a material, the material comprising,
a composite comprising graphite fluoride and a polymer, and
a binder.

18. The cell of claim 17, wherein the cell has an internal resistance of less than about 150 ohms.

19. The cell of claim 18, having a specific capacity of at least 550 mAhg⁻¹, at least 600 mAhg⁻¹, or at least 650 mAhg⁻¹ at discharge rate of C/50.

20. The cell of claim 19, wherein the polymer comprises aniline, derivatives of aniline, pyrrole, derivatives of pyrrole, thiophene, derivatives of thiophene, or mixtures or combinations thereof.
